(19) United States
(12) Patent Application Publication
(10) Pub. No.: US 2015/0114988 A1
(43) Pub. Date: Apr. 30, 2015

(54) Fluid feeding method and nozzle

(71) Applicant: International Tobacco Machinery Poland Sp. z o. o., Radom (PL)

(72) Inventor: Michael Riedel, Radom (PL)

(21) Appl. No.: 14/520,952

(22) Filed: Oct. 22, 2014

(30) Foreign Application Priority Data
Oct. 28, 2013 (PL) P.405790

(51) Int. Cl. A24C 5/00; B05C 5/00; B05D 1/26

(52) U.S. Cl. CPC A24C 5/00; B05D 1/26; B05C 5/00
USPC 222/1; 222/566

(57) ABSTRACT

The substance of the invention is a method of fluid feeding by means of at least one nozzle (4, 4A, 4B, 4C, 4D, 4E) onto a carrier (2) in a machine of the tobacco industry wherein the fluid is fed to the nozzle (4, 4A, 4B, 4C, 4D, 4E) from a fluid container (10) by means of a feeding device (11), whereas the nozzle (4, 4A, 4B, 4C, 4D, 4E) comprises a body (12, 12A) and at least one movable member (13, 13A, 13C, 13E, 13F, 30), and the fluid is fed onto the carrier (2) through an outlet orifice (15, 15A, 15B, 15C, 15D) of the nozzle (4, 4A, 4B, 4C, 4D, 4E). The nozzle (4, 4A, 4B, 4C, 4D, 4E) comprises also an adjusting mechanism (19, 19A, 19B, 19C, 19D) by means of which the reciprocal position of the movable member (13, 13A, 13C, 13E, 13F, 30) and the body (12, 12A) of the nozzle (4, 4A, 4B, 4C, 4D, 4E) is varied by altering the surface area of the outlet orifice (15, 15A, 15B, 15C, 15D) of the nozzle (4, 4A, 4B, 4C, 4D, 4E). The substance of the invention is a nozzle for fluid feeding onto a carrier (2) in a machine of the tobacco industry, comprising a body (12, 12A) and at least one movable member (13, 13A, 13C, 13E, 13F, 30) and an outlet orifice (15, 15A, 15B, 15C, 15D) for fluid feeding onto the carrier (2). The nozzle comprises also an adjusting mechanism (19, 19A, 19B, 19C, 19D) varying the reciprocal position of the movable member (13, 13A, 13C, 13E, 13F, 30) and the body (12, 12A) of the nozzle (4, 4A, 4B, 4C, 4D, 4E) so that the surface area of the outlet orifice (15, 15A, 15B, 15C, 15D) of the nozzle (4, 4A, 4B, 4C, 4D, 4E) is varied.

### BACKGROUND

The object of the invention is a method and a nozzle for fluid feeding.

In the tobacco industry, various rod-like articles such as filters, cigarettes, cigarillos etc. are manufactured. These articles are in general referred to as rods in this description. Tobacco and filter rods are manufactured on machines on which continuous tobacco or filter rods, respectively, are cut into individual rods. The rods manufactured in such a way are then cut into shorter sections which are used to manufacture filter cigarettes. Currently, both filters made of a single filter material and of multiple different materials, so-called multi-segment filters, are used. Rods containing a single type of filter material are formed by cutting a continuous filter rod which is formed by wrapping a filter fibre strand into a paper wrapper. Multi-segment rods are formed by cutting a continuous rod which is formed by wrapping multiple segments of different filter materials. In all cases of rod manufacturing a rotating cutting head with knives situated on its circumference is used for cutting said continuous rods. In case of both filters made of a single material and multi-segment filters it is expected that the contents, for example the components of a filter, do not move in relation to the paper wrapper, whereas a commonly used method of segment fixing is to glue them to the paper wrapper by means of an adhesive usually in the form of a single glue path or multiple glue paths. In case of both tobacco and filter rods also a seam joining the paper wrapper borders is made, whereas usually one or two glue paths are used. Currently, the cigarette manufacturers use various filter materials as well as various filter wrapping materials. From the point of view of joining filter materials and wrapping materials with glue, very significant issues are the spread of glue in the space between the surfaces to be glued and the penetration of glue into the structures of both the wrapping material and the filter material. New filter materials as well as new types of wrapping material require the application of new types of glue which may have a viscosity and a density different from previously used types of glue because they are applied to new joints of the filter material with the wrapping material. The wrapping material, hereinafter referred to as a carrier, may also be an aluminium foil or a foil made of plastic. For manufacturing multi-segment filter rods both smooth and porous segments may be applied within a single rod using a porous paper wrapper. The glue percolates to a different degree into glued elements, which is why it is a very difficult problem to maintain proper glue path parameters, in particular the amount of glue being fed, in order to prevent the glue from leaking through the paper wrapper. The leakage of glue through the paper wrapper results in the contamination of members guiding the continuous rod and the finished rods. The glue depositing on the machine members has to be removed, which makes it necessary to stop the manufacturing machine, and in addition the quality of the rods is decreased. On the part of the manufacturers, there is a demand for the feeding of very thick glue under a very high pressure. In addition, it should be noted that the glue has to be fed with a variable output adjusted to the output of the manufacturing machine. Usually, the pressure of fed glue was varied in order to adjust the fed amount of glue to the variable rod manufacturing speed. In known solutions, keeping up with the variable rod manufacturing speed involves the risk that a placed glue path may have unstable parameters, i.e. may have a different thickness. Moreover, the ways of direct checking of the path quality, for example using optical methods, have not stood the test in production conditions. The nozzles used in the tobacco industry have been disclosed in such documents as: EP1002468A2, U.S. Pat. No. 5,263,608A, EP1442665, known solutions are characterised by a constant diameter of the nozzle outlet orifice as well as a constant distance among the nozzles and a constant distance to the edge of the carrier on which the glue path is placed. The problem to be solved by this invention is to develop an improved nozzle which will facilitate an effective delivery of various adhesives with a variable output in order to achieve constant parameters of the glue path in finished products.

### SUMMARY OF THE INVENTION

The substance of the invention is a method of fluid feeding by means of at least one nozzle onto a carrier in a machine of the tobacco industry wherein the fluid is fed to the nozzle from a fluid container by means of a feeding device. The nozzle comprises a body and at least one movable member, and the fluid is fed onto the carrier through an outlet orifice of the nozzle, and the method according to the invention is characterised in that the nozzle comprises also an adjusting mechanism, and by means of the adjusting mechanism the reciprocal position of the movable member and the nozzle body is varied by altering the surface area of the outlet orifice of the nozzle.

A method according to the invention is characterised in that the surface area of the outlet orifice is varied by displacing and/or turning at least one movable member relative to the body of the nozzle.

A method according to the invention is characterised in that the surface area of the outlet orifice of the nozzle is varied depending on the pressure of the fluid being fed.

A method according to the invention is characterised in that the surface area of the outlet orifice of the nozzle is varied so that the pressure of the fluid being fed is maintained at a constant level.

A method according to the invention is characterised in that the surface area of the outlet orifice of the nozzle is varied proportionally to the pressure of the fluid being fed.

A method according to the invention is characterised in that the surface area of the outlet orifice of the nozzle is varied depending on at least one of such parameters as type of fluid, fluid temperature, carrier travel speed, type of carrier, output of the feeding device.

A method according to the invention is characterised in that the surface area of the outlet orifice of the nozzle is varied in a feedback loop in the function of at least one of such parameters as fluid pressure, fluid temperature, carrier travel speed and output of the feeding device.

A method according to the invention is characterised in that the nozzle comprises at least two outlet orifices, and the surface areas of the outlet orifices are varied independently of one another.

A method according to the invention is characterised in that the nozzle comprises at least two outlet orifices, and the position of the outlet orifices is varied relative to one another and/or relative to an edge of the carrier.

Furthermore, the substance of the invention is a nozzle for fluid feeding onto a carrier in a machine of the tobacco industry comprising a body and at least one movable member, and an outlet orifice for the feeding of the fluid onto the carrier, characterised by comprising also an adjusting mechanism varying the reciprocal position of the movable member and the nozzle body so that the surface area of the outlet orifice of the nozzle is varied.

A nozzle according to the invention is characterised in that the movable member and the nozzle body are mounted in so that their reciprocal displacement and/or rotation is/are possible.

A nozzle according to the invention is characterised in that the nozzle comprises at least two outlet orifices and is adjusted in so that the surface areas of the outlet orifices are varied independently of one another.

A nozzle according to the invention is characterised in that the nozzle comprises at least two outlet orifices and is adjusted in so that the position of the outlet orifices is varied relative to one another and/or relative to the edge of the carrier.

A nozzle according to the invention is characterised in that the movable member is a cylinder.

A nozzle according to the invention is characterised in that at least one outlet orifice of the nozzle has edges situated obliquely to one another.

Due to the use of a method and a nozzle according to the invention the quality of the manufactured rods is increased. In the consequence of it the amount of production waste is reduced. The efficiency of the manufacturing machine is increased by reducing the machine downtime spent on cleaning the excessively contaminated members of the machine.

### DESCRIPTION OF THE DRAWING

A method and a nozzle according to the invention have been presented in detail in preferred embodiments in a drawing in which:

FIG. 1 shows a fragment of a production machine for manufacturing multi-segment rods;

FIG. 2 shows a nozzle in a first embodiment;

FIG. 3 shows a cross-section through the nozzle of FIG. 2;

FIG. 4 shows a view of the nozzle of FIG. 3 from the side of the carrier in one position of the nozzle;

FIG. 5 shows a view of the nozzle of FIG. 3 from the side of the carrier in another position of the nozzle;

FIG. 6 shows a nozzle in a second embodiment in a view from the side of the carrier in one position of the nozzle;

FIG. 7 shows the nozzle in the second embodiment in a view from the side of the carrier in another position of the nozzle;

FIG. 8 shows a nozzle in a third embodiment in a view from the side of the carrier in one position of the nozzle;

FIG. 9 shows the nozzle in the third embodiment in a view from the side of the carrier in another position of the nozzle;

FIG. 10 shows a nozzle in a fourth embodiment in a view from the side of the carrier in one position of the nozzle;

FIG. 11 shows the nozzle in the fourth embodiment in a view from the side of the carrier in another position of the nozzle;

FIG. 12 shows a nozzle in a fifth embodiment in a view from the side of the carrier in one position of the nozzle;

FIG. 13 shows the nozzle in the fifth embodiment in a view from the side of the carrier in another position of the nozzle;

FIG. 14 shows a nozzle in a sixth embodiment in a view from the side of a carrier;

FIG. 15 shows the nozzle of FIG. 14 in a cross-section through one of the movable members;

FIG. 16 shows the nozzle of FIG. 14 in a cross-section through movable members; and

FIG. 17 shows a carrier with fluid paths spread on it.

### DETAILED DESCRIPTION

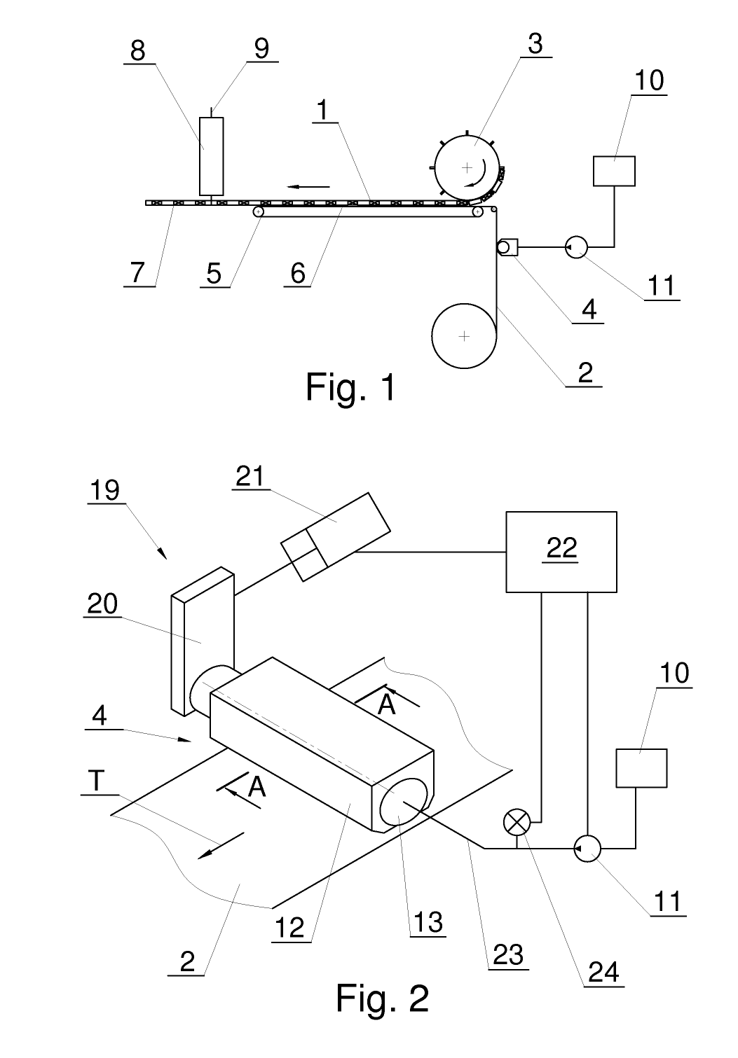

FIG. 1 shows a fragment of a machine for manufacturing multi-segment rods. Rod-shaped segments 1 are fed onto a paper wrapper 2 from any not shown segment feeding device. For example, a member directly placing the segments onto the paper wrapper may be a delivery wheel 3. A machine for manufacturing multi-segment rods is provided with a conveyor 5 on which the paper wrapper 2 moves together with a tape 6. The segments 1 are fixed in relation to the paper wrapper 2 by means of the adhesive. A nozzle 4 is used to feed glue onto the paper wrapper before placing the segments onto it. After wrapping the segments into the paper wrapper and sealing the paper wrapper, a continuous multi-segment rod is formed and the said continuous rod is cut into individual multi-segment rods 7 by means of a cutting head 8 provided with knives 9. The nozzle 4 may be used to feed glue or fluid being a solvent or one of the glue components. Also water may be fed by means of the nozzle 4 if glue layer has already been applied onto the paper wrapper. A general name of fluid generally relating to any of the abovementioned substances will be hereinafter used. The fluid is fed from a fluid container 10 by means of a pump 11 or any feeding device. The fluid may be fed onto a paper or foil wrapper or generally onto a carrier used in the tobacco industry machines.

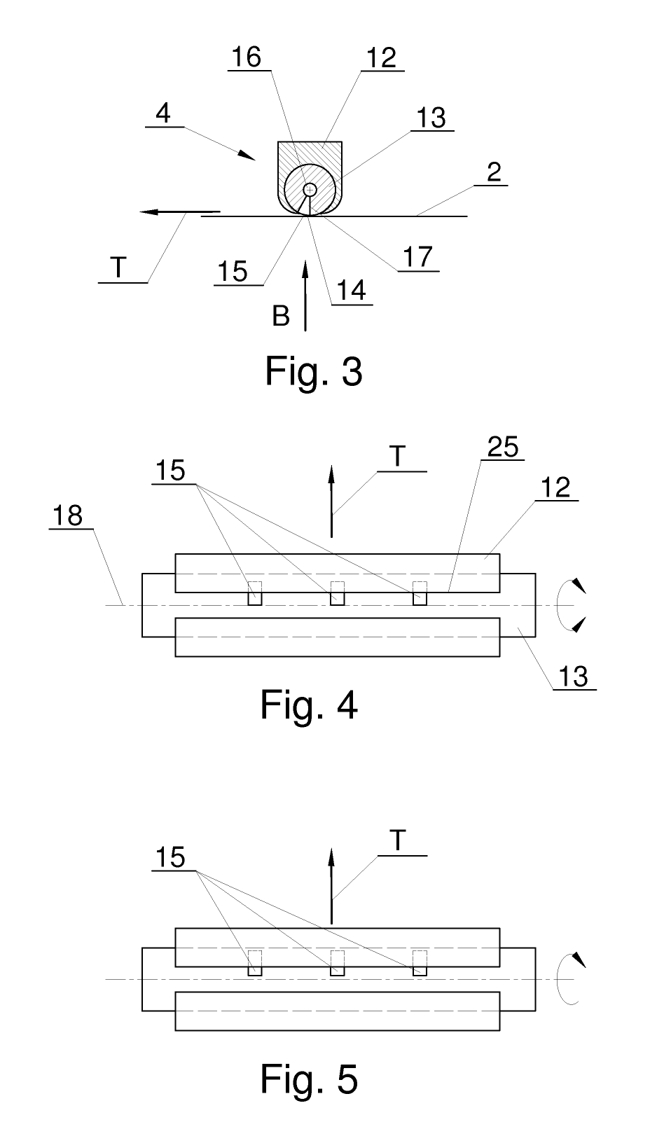

FIG. 2 shows a nozzle 4 according to the invention in a first embodiment. The nozzle 4 is situated in the machine next to the carrier 2 used to wrap the segments 1 of a continuous multi-segment rod, whereas the carrier may move vertically or horizontally. The nozzle 4 has a body 12 and a movable member situated within it having the form of a cylindrical movable member 13, whereas the body 12 and the movable member 13 have been shown in FIG. 3 in a cross-section designated in FIG. 2 as A-A. The movable member 13 has a longitudinal channel 16 formed inside and at least one transverse channel 17 ending with an outlet orifice 14. The orifices 14 are partly covered with an edge 25 of a body 12 so that the nozzle 4 outlet orifices 15 with a variable surface area shown in FIG. 4 are formed, whereas the outlet orifices 15 are sectors of the cylinder lateral surface. The outlet orifices 15 may remain in a direct contact with the carrier 2 or at a certain distance from the carrier 2 moving in the direction shown by the arrow 20. A variation of the surface area of the outlet orifices 15 is achieved by a rotation of the movable member 13 forced by an adjusting mechanism 19 shown in FIG. 2 comprising a lever 20 driven by a drive member 21, whereas a drive signal whose purpose is to vary the surface area of the outlet orifice 15 comes from a control unit 22. FIGS. 4 and 5 show the nozzle in two different positions of the movable member 13 rotating around the axis 18. FIGS. 4 and 5 do not show the carrier, but only the direction of its movement. The drive member 21 may be an electromagnetic, pneumatic, hydraulic or other member.

The fluid from the container 10 is fed to the nozzle 4 by means of a pump 11 through a conduit 23 of a longitudinal channel 16 formed inside the movable member 13 and further through transverse channels 17 to the outlet orifices 15. A pressure sensor 24 which sends a signal to a control unit 22, informing about the current pressure of the fluid being fed, is situated on a conduit 23 feeding the nozzle 4 with the fluid. The control unit 22 may control the output of the pump 11 in order to adjust its output to the current fluid requirement. In order to facilitate the adjustment of the output of a feeding device, for example a metering pump, a signal from the manufacturing machine informing about the current travel speed of the carrier 2, thus about the fluid feeding output required to ensure a constant seam quality, is delivered to the control unit. In addition, with increasing fluid requirement, the nozzle is adjusted by the control unit 22 so that the surface area of the outlet orifices 15 is increased. With decreasing travel speed of the carrier 2, the control unit 22 causes a reduction of the surface area of the outlet orifices 15. Optimally, the control unit, by means of an adjusting mechanism, controls the position of the movable member 13 so that a substantially constant fluid pressure at the inlet to the nozzle 4 is maintained. The control of the position of the movable member 13 may be accomplished in a feedback loop taking the fluid pressure, the carrier travel speed or the fluid temperature into consideration. The control of the position of the movable member 13, thus of the surface area of the outlet orifice 15, may be dependent on the type of the carrier material, and the type or temperature of the fluid.

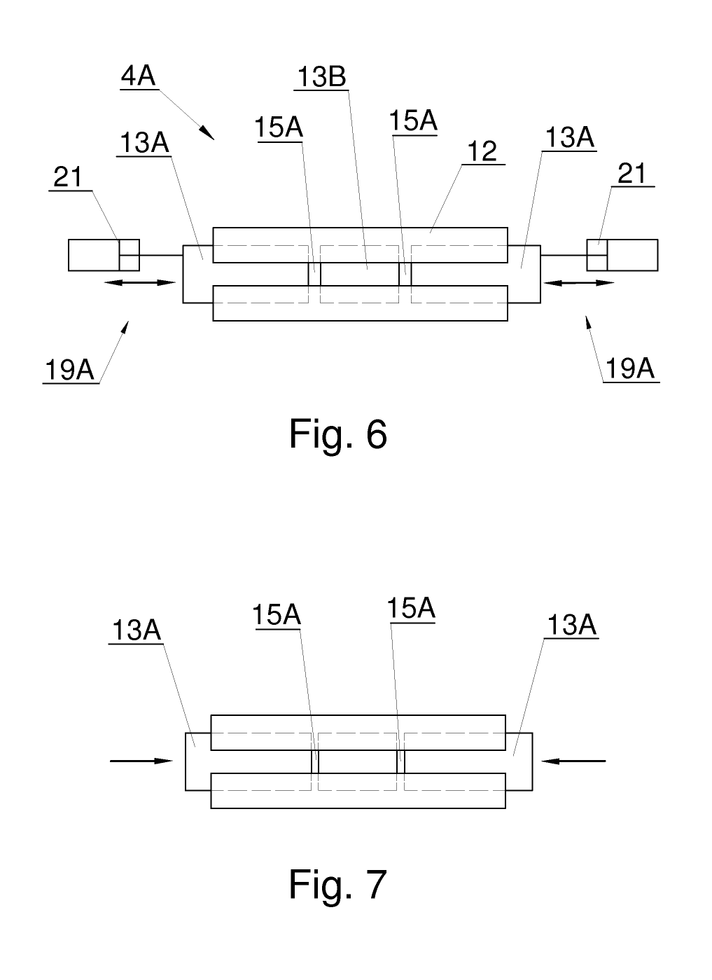

FIGS. 6 and 7 show a nozzle 4A in a second embodiment. The nozzle 4A is provided with a body 12, two movable members embodied as slidable members 13A and one stationary member 13B. The slidable members 13C and drive members 21 are parts of the adjusting mechanisms 19A. A variation of the surface area of outlet orifices 15A is achieved by axially displacing the slidable members 13A. FIG. 7 shows the nozzle 4A with reduced outlet orifices 15A after the displacement of members 13A in the direction designated by the arrows.

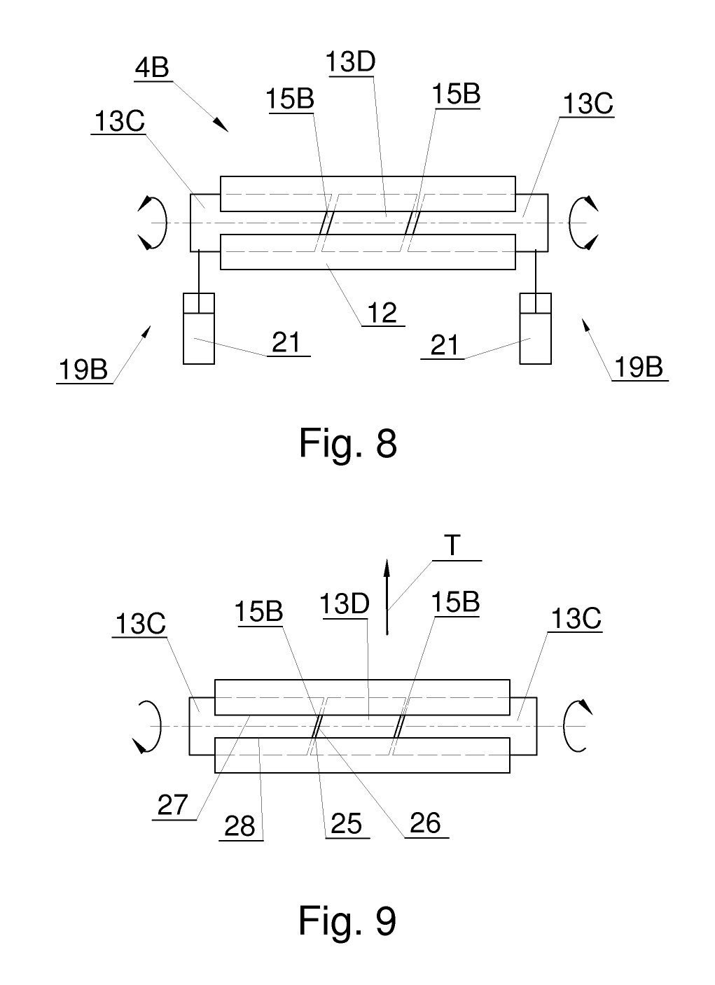

FIGS. 8 and 9 show a nozzle 4B in a third embodiment. The nozzle 4B is provided with a body 12, two movable members embodied as rotatable members 13C and one stationary member 13D. The members 13C and 13D have spiral edges 25 and 26. Outlet orifices 15B are formed by the edges 25, 26 as well as 27 and 28. Rotatable members 13C and drive members 21 are parts of the adjusting mechanisms 19B. A variation of the surface area of outlet orifices 15B is achieved by rotating the rotatable members 13C. FIG. 9 shows the nozzle 4B with reduced orifices 15B.

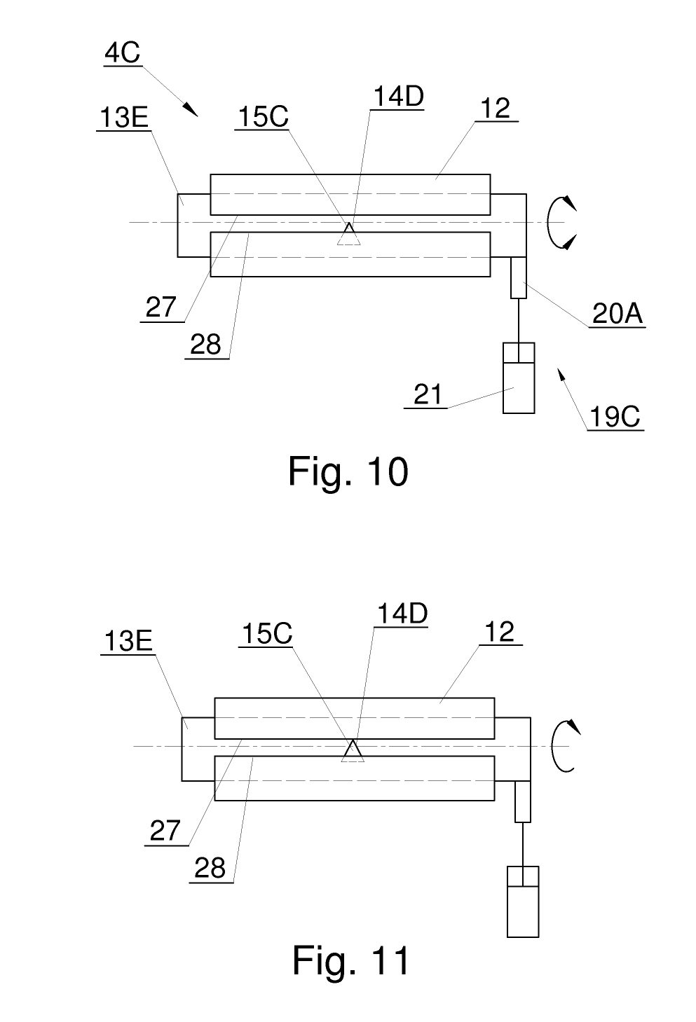

FIGS. 10 and 11 show a nozzle 4C in a fourth embodiment. The nozzle 4C has a rotatable member 13E which has an orifice 14D made in the shape of a triangle and situated on the lateral cylindrical surface of the rotatable member 13E. An outlet orifice 15C of the nozzle 4C is formed by covering the orifice 14D with the edges 27 and/or 28. A lever 20A and a drive member 21 are parts of an adjusting mechanism 19C. A variation of the surface area of an outlet orifice 15C is achieved by rotating the rotatable member 13E by means of the adjusting mechanism 19C. A variable triangular surface area of an outlet orifice 15C may, after the rotation, maintain the shape of a triangle or, after covering the vertex of the triangle, take the shape of a trapezoid. Generally, a variable outlet orifice has at least two edges situated obliquely to each other.

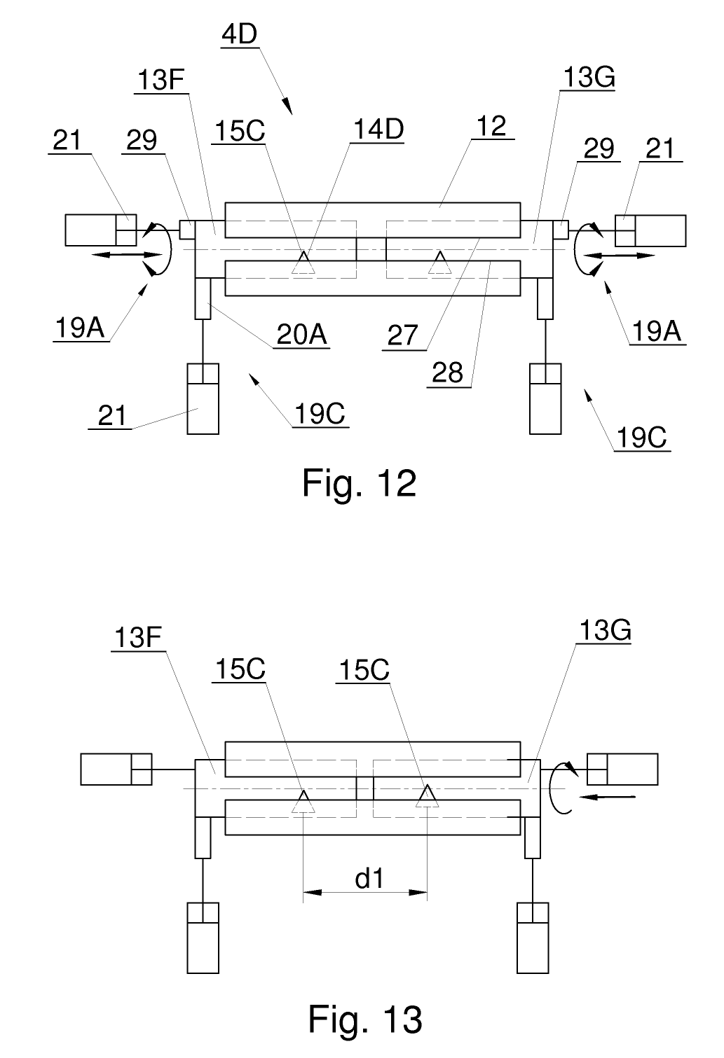

FIGS. 12 and 13 show a nozzle 4D in a fifth embodiment. The nozzle 4D has two movable members 13F and 13G, each having an orifice 14D in the shape of a triangle similar to the preceding embodiment. The outlet orifices 15C of a nozzle 4D are formed by covering the orifices 14D with edges 27 and 28. The members 13F and 13G are embodied as slidable rotatable members. A connector 29 and a drive member 21 are parts of an adjusting mechanism 19A which displaces the members 13F or 13G axially. Furthermore, a lever 20A and a drive member 21 are parts of an adjusting mechanism 19C which causes a rotational movement of the members 13F or 13G. Similarly to the preceding embodiment, a variation of the surface area of at least one outlet orifice 15C is achieved by rotating the members 13F and/or 13G. FIG. 13 shows the nozzle 4D in a situation where the member 13G has been rotated and displaced so that the surface area of the outlet orifice 15C in the member 13G has increased and the distance d between the orifices 15C in the members 13F and 13G has varied. The fluid delivered to the outlet orifices 15C may be of one type or may be delivered from two separate containers containing different fluids with different functional parameters.

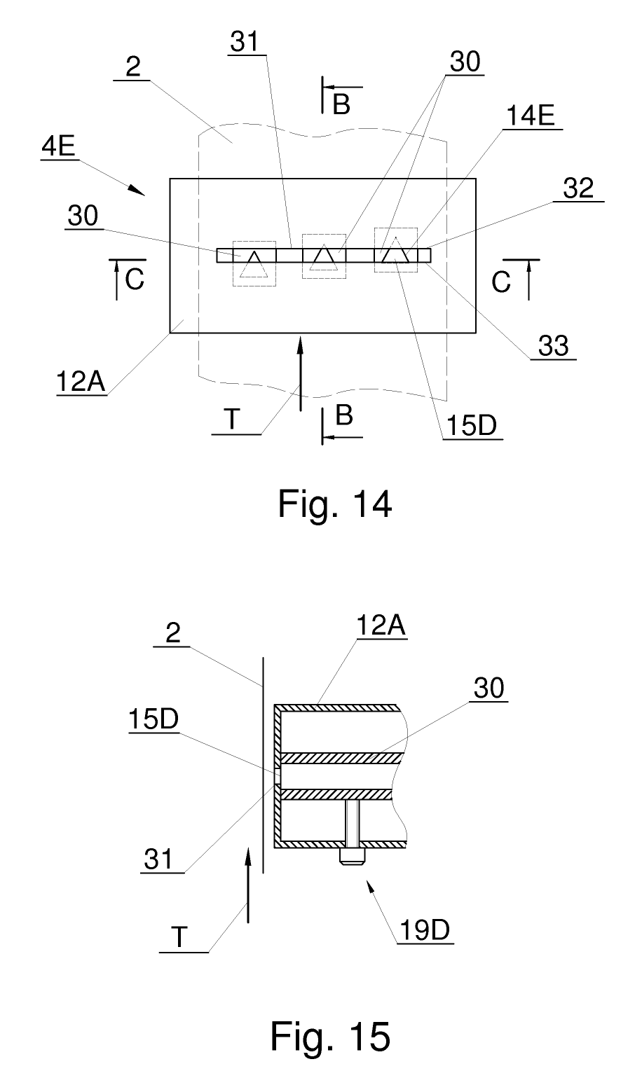

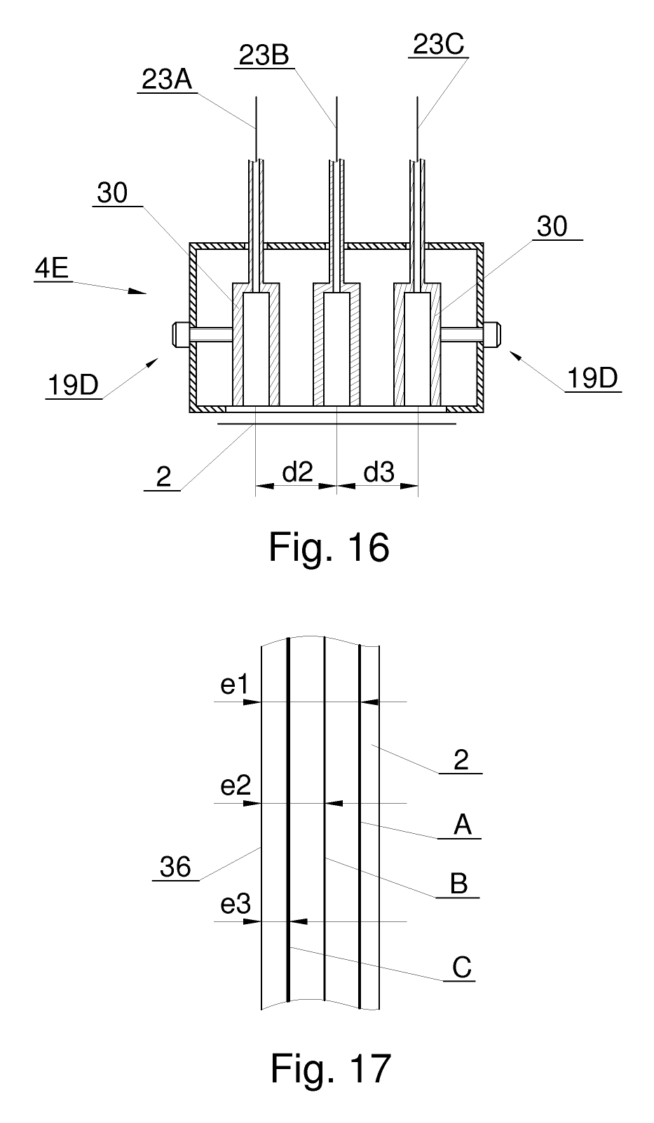

FIG. 14 shows a nozzle 4E in a sixth embodiment. The nozzle 4E has three movable members 30, with each of these members having an orifice 14E situated next to a slot 31 made in a body 12A. The orifices 14E together with the edges 32 and 33 form the outlet orifices 15D. FIG. 15 shows a cross-section through a movable member 30 designated in FIG. 14 as B-B. A variation of the surface area of the outlet orifice 15D is achieved by displacing the member 30 transversely to the slot 31, that is substantially in the direction corresponding to the direction of movement 20 of a carrier 2. A displacement of the member 30 may be accomplished for example by means of a helical mechanism 19D adjusted manually or similar to the preceding embodiments by means of a drive member 21 and a control unit 22. FIG. 16 shows the nozzle 4E in a cross-section designated in FIG. 12 as C-C. The left and the right movable members 30 may be additionally displaced in the direction transverse to the direction of movement 20 of the carrier 2 by means of a helical mechanism 19D. This allows achieving a variable distance of the paths along which the fluid is spread as shown in FIG. 17. Individual paths A, B and C are situated at the distances e1, e2 and e3, respectively, from an edge 36 of the carrier 2. A fluid of one type or fluids of different types may be delivered to the individual members 30 through conduits 23A, 23B and 23C.

1. A method of fluid feeding by means of at least one nozzle (4, 4A, 4B, 4C, 4D, 4E) onto a carrier (2) in a machine of the tobacco industry wherein the fluid is fed to a nozzle (4, 4A, 4B, 4C, 4D, 4E) from a fluid container (10) by means of a feeding device (11), whereas
the nozzle (4, 4A, 4B, 4C, 4D, 4E) comprises a body (12, 12A) and at least one movable member (13, 13A, 13C, 13E, 13F, 30), and the fluid is fed onto the carrier (2) through an outlet orifice (15, 15A, 15B, 15C, 15D) of the nozzle (4, 4A, 4B, 4C, 4D, 4E),
characterised in that
the nozzle (4, 4A, 4B, 4C, 4D, 4E) comprises also an adjusting mechanism (19, 19A, 19B, 19C, 19D), and
by means of an adjusting mechanism (19, 19A, 19B, 19C, 19D) the reciprocal position of the movable member (13, 13A, 13C, 13E, 13F, 30) and the body (12, 12A) of the nozzle (4, 4A, 4B, 4C, 4D, 4E) is varied by altering the surface area of the outlet orifice (15, 15A, 15B, 15C, 15D) of the nozzle (4, 4A, 4B, 4C, 4D, 4E).

2. The method as in claim 1 characterised in that the surface area of the outlet orifice (15, 15A, 15B, 15C, 15D) is varied by displacing and/or rotating at least one movable member (13, 13A, 13C, 13E, 13F, 30) relative to the body (12, 12A) of the nozzle (4, 4A, 4B, 4C, 4D, 4E).

3. The method as in claim 1 characterised in that the surface area of the outlet orifice (15, 15A, 15B, 15C, 15D) of the nozzle (4, 4A, 4B, 4C, 4D, 4E) is varied depending on the pressure of the fluid being fed.

4. The method as in claim 3 characterised in that the surface area of the outlet orifice (15, 15A, 15B, 15C, 15D) of the nozzle (4, 4A, 4B, 4C, 4D, 4E) is varied in so that the pressure of the fluid being fed is maintained at a constant level.

5. The method as in claim 3 characterised in that the surface area of the outlet orifice (15, 15A, 15B, 15C, 15D) of the nozzle (4, 4A, 4B, 4C, 4D, 4E) is varied proportionally to the pressure of the fluid being fed.

6. The method as in claim 1 characterised in that the surface area of the outlet orifice (15, 15A, 15B, 15C, 15D) of the nozzle (4, 4A, 4B, 4C, 4D, 4E) is varied depending on at least one of such parameters as type of fluid, fluid temperature, carrier travel speed, type of carrier, output of the feeding device.

7. The method as in claim 1 characterised in that the surface area of the outlet orifice (15, 15A, 15B, 15C, 15D) of the nozzle (4, 4A, 4B, 4C, 4D, 4E) is varied in a feedback loop in the function of at least one of such parameters as fluid pressure, fluid temperature, carrier travel speed, output of the feeding device.

8. The method as in claim 1 characterised in that the nozzle (4, 4A, 4B, 4C, 4D, 4E) comprises at least two outlet orifices (15, 15A, 15B, 15C, 15D), and the surface areas of the outlet orifices (15, 15A, 15B, 15C, 15D) are varied independently of one another.

9. The method as in claim 1 characterised in that the nozzle (4, 4A, 4B, 4C, 4D, 4E) comprises at least two outlet orifices (15, 15A, 15B, 15C, 15D), and the position of the outlet orifices (15, 15A, 15B, 15C, 15D) is varied relative to one another and/or relative to an edge (35) of the carrier (2).

10. A nozzle for fluid feeding onto a carrier (2) in a machine of the tobacco industry, comprising a body (12, 12A) and at least one movable member (13, 13A, 13C, 13E, 13F, 30) and an outlet orifice (15, 15A, 15B, 15C, 15D) for fluid feeding onto the carrier (2),
characterised by
comprising also an adjusting mechanism (19, 19A, 19B, 19C, 19D) varying the reciprocal position of the movable member (13, 13A, 13C, 13E, 13F, 30) and a body (12, 12A) of the nozzle (4, 4A, 4B, 4C, 4D, 4E) so that the surface area of the outlet orifice (15, 15A, 15B, 15C, 15D) of the nozzle (4, 4A, 4B, 4C, 4D, 4E) is varied.

11. The nozzle as in claim 10 characterised in that the movable member (13, 13A, 13C, 13E, 13F, 30) and the body (12, 12A) of the nozzle (4, 4A, 4B, 4C, 4D, 4E) are mounted so that their reciprocal displacement and/or rotation is/are possible.

12. The nozzle as in claim 10 characterised in that the nozzle (4, 4A, 4B, 4C, 4D, 4E) comprises at least two outlet orifices (15, 15A, 15B, 15C, 15D) and is adjusted so that the surface areas of the outlet orifices (15, 15A, 15B, 15C, 15D) are varied independently of one another.

13. The nozzle as in claim 10 characterised in that the nozzle comprises at least two outlet orifices (15, 15A, 15B, 15C, 15D) and is adjusted so that the position of the outlet orifices (15, 15A, 15B, 15C, 15D) is varied relative to one another and/or relative to an edge (36) of the carrier (2).

14. The nozzle as in claim 10 characterised in that the movable member (13, 13A, 13C, 13E, 13F, 30) is a cylinder.

15. The nozzle as in claim 10 characterised in that at least one outlet orifice (15, 15A, 15B, 15C, 15D) of the nozzle (4, 4A, 4B, 4C, 4D, 4E) has edges situated obliquely to one another.
